(19) United States
(12) Patent Application Publication
(10) Pub. No.: US 2020/0001742 A1
(43) Pub. Date: Jan. 2, 2020

(54) AUTOMOTIVE VEHICLE SEAT

(71) Applicant: Faurecia Sièges d'Automobile, Nanterre (FR)

(72) Inventors: David EPAUD, Lardy (FR); Farouk BOUZID, Bretigny Sur Orge (FR)

(21) Appl. No.: 16/455,546

(22) Filed: Jun. 27, 2019

(30) Foreign Application Priority Data
Jun. 28, 2018 (FR) 18 55919

(51) Int. Cl. B60N 2/02; B60N 2/10; B60N 2/829

(52) U.S. Cl. CPC B60N 2/0224; B60N 2/829; B60N 2/10

(57) ABSTRACT

An automotive vehicle seat includes first and second mechanisms and a command device having a rotary actuator connected to the first mechanism and to the second mechanism. The rotary actuator is elastically urged towards a rest position, and the command device is configured to command the first mechanism when the rotary actuator is actuated in a first rotation direction from the rest position and configured to command the second mechanism when the rotary actuator is actuated in the second direction of rotation opposite to the first direction of rotation from the rest position.

### TECHNICAL FIELD

The present description relates to automotive vehicle seats. More specifically, the present description relates to automotive vehicle seats provided with mechanisms for movement of movable parts of the automotive vehicle seat.

### SUMMARY

The goal of the present description is in particular to improve seats of this type to make actuation thereof by a user easier.

For this purpose, the present description proposes an automotive vehicle seat comprising a first mechanism, a second mechanism and a command device comprising a rotary actuator connected to the first mechanism and to the second mechanism, where the rotary actuator is elastically urged towards a rest position, and where the command device is configured to command the first mechanism when the rotary actuator is actuated in a first rotation direction from the rest position and configured to command the second mechanism when the rotary actuator is actuated in the second direction of rotation opposite to the first direction of rotation from the rest position.

Thus the seat can comprise a reduced number of elements and can be particularly simple to use because the command of various mechanisms is centralized and made easier.

In various embodiments, use could furthermore be made of one and/or the other of the following dispositions:
The rotary actuator is elastically urged by a spring, preferably a spiral spring;
The seat further comprises a first cable connected to the first mechanism and a second cable connected to the second mechanism, where the first cable has one end fixed to the rotary actuator and the second cable has one end fixed to the rotary actuator;
The rotary actuator comprises a peripheral groove in which the first cable and the second cable are engaged;
The automotive vehicle seat further comprises a third mechanism where the command device is configured to command the first mechanism when the rotary actuator is moved in the first direction of rotation by at least a first angle starting from the rest position, and configured to command the third mechanism when the rotary actuator is actuated in the first direction of rotation by at least a second angle starting from the rest position, where the second angle is greater than the first angle;
The seat further comprises a third cable connected to the third mechanism, where the third cable has one end fixed to the rotary actuator, and where the third cable is mounted sliding in a sleeve having one sleeve end towards the rotary actuator, where said third cable end and the sleeve end are substantially aligned with a radial direction relative to the axis of rotation of the rotary actuator when said rotary actuator is in the rest position;
The seat comprises a seat bottom and a seatback mounted pivoting around a horizontal axis of rotation, where the first mechanism is configured to command the seatback to fold down forward and/or where the second mechanism is configured to command a tilting of the seat forward;
The seat comprises a headrest mounted movable upward and downward on the seatback, where the third mechanism is configured to command a retraction of said headrest to low position;
The command device comprises a command member suitable for allowing a user to actuate the rotary actuator.

### BRIEF DESCRIPTION OF THE DRAWINGS

Other features and advantages will become apparent during the following description of one of the embodiments thereof, given as a nonlimiting example, with reference to the attached drawings.

In the drawings:

FIG. 1 is a schematic view of the vehicle seat;

FIG. 2 is a perspective view of the frame of the seat from FIG. 1;

FIG. 3 is a detail view of the seat frame from FIG. 1;

FIG. 4a is a side view of the seat frame from FIG. 2 in a position where the seat is folded down forward, and FIG. 4b is a detailed view of a zone of the seat frame from FIG. 2;

FIG. 5 is an exposed, perspective detail view of a command device for the seat from FIGS. 1 to 3; and

FIGS. 6, 7 and 8 are views of a rotary actuator belonging to the command device from FIG. 5, respectively in three actuation positions.

### DETAILED DESCRIPTION

In the various figures, the same references designate identical or similar items.

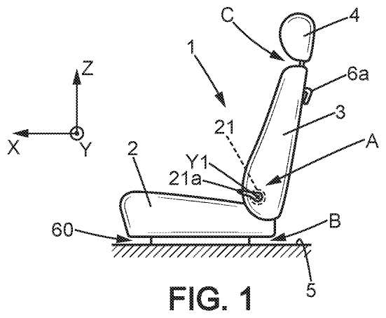

FIG. 1 shows an automotive vehicle seat 1. The seat 1 comprises a seat bottom 2 intended to receive an occupant of the seat 1 and the seatback 3 born by the seat bottom.

The seat bottom 2 is fixed to a fixed structure, in particular the floor 5 of the vehicle. It can be mounted on the floor with sliders 60 allowing forward and backward adjustment of the position of the seat bottom 2 on the floor, along a horizontal, longitudinal direction X. It can further be provided with a link mechanism B providing a forward tilting of the seat 1 relative to the floor 5 during passage from the rest position to a forward folded down position, in particular in the case of a three-door vehicle for clearing access to places behind the seat 1.

The seatback 3 can be inclinable relative to the seat bottom 2 because of at least one first mechanism A comprising at least one articulation mechanism 21, by pivoting around a first transverse horizontal axis of rotation Y1, oriented along a horizontal, transverse direction Y perpendicular to the axis X. The articulation mechanism 21 can generally be commanded by the occupant, for example by a command handle 21a for adjusting an inclination of the seatback when the occupant is seated in the seat. Further, the mechanism A can be actuated for folding the seatback 3 down forward, for example horizontally in tray table position.

The seat 1 can further comprise a headrest 4 supported by the seatback 3. The headrest can be adjustable in height, substantially along the vertical direction Z, by height adjustment mechanism C which also allows a retraction C with allows to retract the headrest 4 towards the bottom position to avoid it interfering with any element located in front of the seat 1, in particular when the seatback 3 is folded down on the seat bottom 2, or even with the ceiling of the cabin of the vehicle in particular during tilting the seat 1 forward.

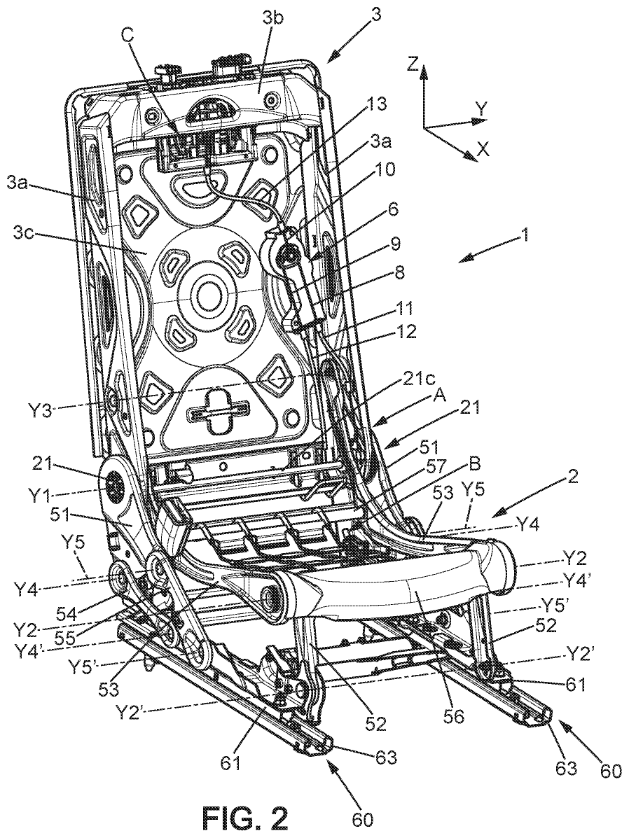

The seat 1 can further be provided with a command member 6a such as a handle, an electronic or other command means, that allows the user to actuate a command mechanism 6 (see FIG. 2) for commanding at least two mechanisms of the seat, for example two of the mechanisms A, B and C, or all three. In the example which will be described below, the command member 6a commands the three mechanisms A, B and C, but this example is not limiting. The command member 6a can for example be laid out on the rear surface or on the side of the seatback 3, in particular when it is intended to be used by a user not seated on the seat 1 as is the case in the example considered here.

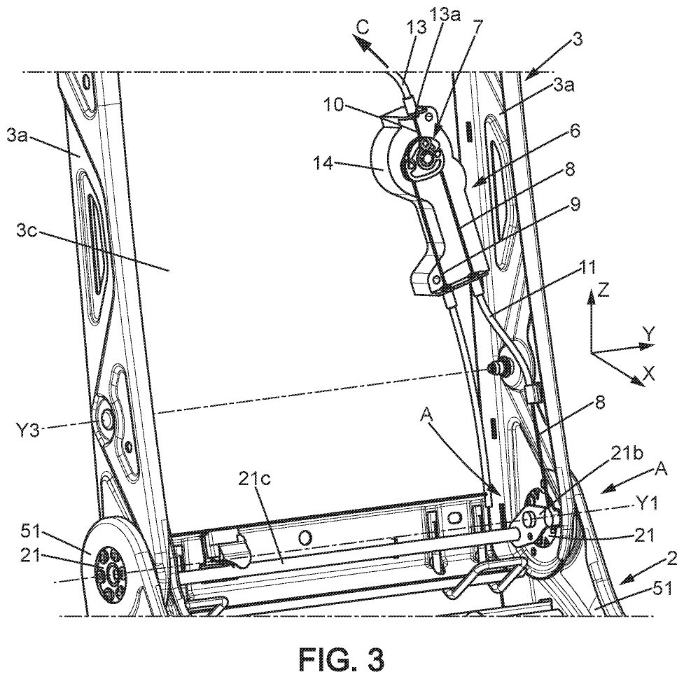

The frame of the seat 1, shown in FIGS. 2 to 4 in a non-limiting embodiment example, can in particular be metal or another stiff material.

The frame of the seatback 3 can for example comprise two lateral side plates 3a, an upper crosspiece 3b which carries the headrest 4 retraction mechanism C and the back 3c on which the command mechanism 6 could be attached.

The headrest retraction mechanism C can for example be like the one described in the document FR 3,000,708 A1. It can be actuated by traction on a cable 10 sliding in a sleeve 13, where the cable 10 is connected to the command mechanism 6 as will be described below.

The frame of the seat bottom 2 can be fixed to the respective movable profiles 61 of the sliders 60, where each movable profile 61 is mounted slidably along the longitudinal direction X on a fixed profile 63 secured to the floor 5 of the vehicle.

The frame of the seat bottom 2 can in particular comprise two lateral side plates 51 and two lateral, curved connecting arms 53. The lateral side plates 51 and the curved connecting arms 53 each extend in a plane parallel to the longitudinal direction X and the vertical direction Z.

The lateral side plates 51 are respectively connected to the movable profiles 61 of the sliders. In the example shown, the lateral side plates 51 are respectively connected to the movable profiles 61 of the sliders by two rear connecting arms 54, 55 and are locked on these movable profiles by the aforementioned link mechanism B.

Each rear connecting arm 54 is mounted pivoting freely on the lateral side plate 51 near a transverse axis of rotation Y4 and on the movable profile 61 near a transverse axis of rotation Y′4, where these two axes of rotation are parallel to the transverse direction Y. Each rear connecting arm 55 is mounted pivoting freely on the lateral side plate 51 near a transverse axis of rotation Y5 and on the movable profile 61 near a transverse axis of rotation Y′5, where these two axes of rotation are parallel to the transverse direction Y.

Further, the lateral side plates 3a of the seatback are mounted pivoting on the lateral side plates 51 of the seat bottom around the aforementioned first transverse axis of rotation Y1, by the one or more articulation mechanisms 21. In the example shown, the seat 1 comprises two articulation mechanisms 21 respectively on the two sides of the seat, connected to each other by a command shaft 21c secured to a command lever 21b. The command lever 21b can be commanded by the command mechanism 6 to which it is connected by cable 8 sliding in a sleeve 11, as will be explained later, in order to actuate the command lever 21b and unlock the two articulation mechanisms 21 by traction on the cable 8. The first mechanism A is therefore formed, in the specific example considered here, by the articulation mechanisms 21, the command lever 21b and the command shaft 21c.

The articulation mechanisms 21 can be locking mechanisms with toothed locking elements each commanded by an internal cam, well known in themselves. They can be of the type allowing the seatback 3 to fold down forward freely once the seatback 3 has left a range of angular positions for comfort adjustment. For example, the articulation mechanisms 21 can be such as described in the document FR2811947, or take other known configurations designed for this purpose.

As a variant, the cable 8 could be connected to one of the hooks or the like such as described in particular in the document FR 2,915,934 A1, for commanding the folding down of the seatback 3 into a tray table. This type of hook, well known in itself, can for example be mounted pivoting on the seatback and come to be held with the corresponding movable lateral side plate of the articulation mechanism 21, for selectively securing the movable lateral side plate with the seatback or allowing the seatback to fold down freely.

The curved connecting arms 53 can be rigidly connected to each other by a front crosspiece 56 and a rear crosspiece 57.

The front ends of the curved connecting arms 53 are mounted respectively on two front connecting arms 52. The upper end of each front connecting arm 52 is connected to the curved connecting arms 53 so as to pivot freely around the second transverse axis of rotation Y2 parallel to the direction Y. The lower end of each front connecting arm 52 is mounted pivoting on the movable profile 61 of the corresponding slider around a transverse axis of rotation Y′2 parallel to the transverse direction Y.

The rear ends of the curved connecting arms L1 are mounted freely in rotation on the lateral side plates 3a of the seatback around a third transverse axis of rotation Y3 parallel to the transverse direction Y. The third axis Y3 is located between the first axis Y1 and the upper end of the seat, therefore above the articulation mechanisms 21 in the normal position of use of the seat. According to a variant, the third axis Y3 can be located below the articulation mechanisms 21 in the normal position of use of the seat.

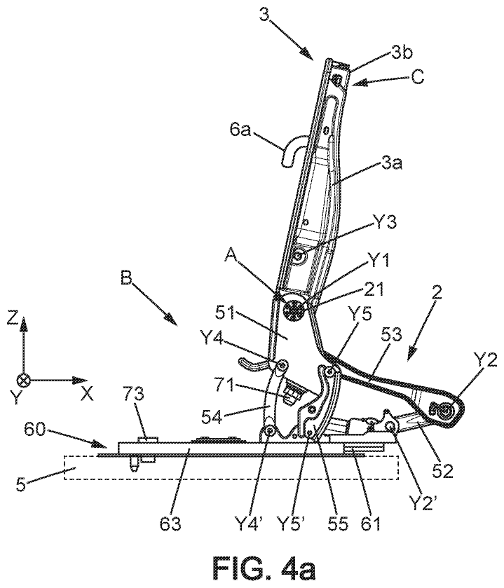

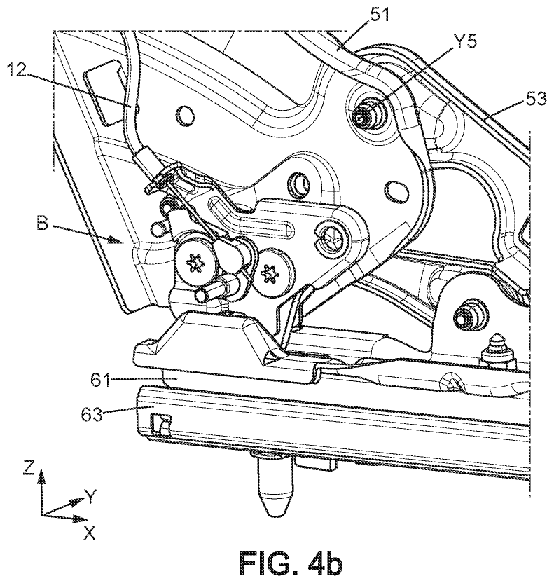

The link mechanism B can be commanded by command mechanism 6, via a cable 9 sliding in a sleeve 12 (FIGS. 2, 3, 4b). As shown in FIG. 4a and as described in the French patent application filed under number 17/058802, the link mechanism B can comprise at least one first element 71 secured to the seat bottom 2 and a second element 73 secured to the movable profiles 61 of the sliders 60. The first element 71 can be a male element and the second element 73 can be a female element such as a catch receiving the first element 71. The first element 71 can for example be a rod provided with retractable bearings of the type of those described in the document FR 2,793,199 A1, or even a movable hook or the like.

The link mechanism B, when it is unlocked by traction on the cable 9 as shown in FIG. 4a, allows the tilting forward of the seat bottom 2 and therefore of the seat assembly 1, because of the connecting arms 54, 55, 52.

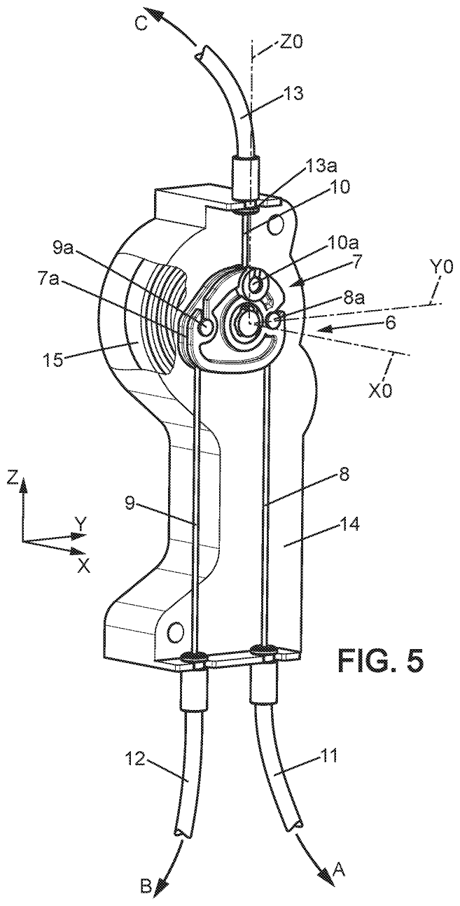

The command device 6, which is shown in more detail in FIG. 5, can comprise a case 14 which can be attached for example to the frame of the seatback 3. The case 14 can be made for example of plastic.

The command device 6 comprises a rotary actuator 7 which can for example be secured to the aforementioned command member 6a. The rotary actuator 7 can be mounted rotating on the case 14, for example around an axis of rotation X0 included in the XZ plane.

The rotary actuator 7 is elastically urged towards the rest position, visible in FIG. 5, for example by a spring 15 such as a spiral spring or the like which can for example be contained in the case 14.

The rotary actuator 7 is secured to the respective ends 8a, 9a, 10a of the three cables 8, 9, 10. Said ends 8a, 9a, 10a of the cables could be formed by pins engaged in notches in the rotary actuator 7.

The rotary actuator 7 forms a pulley provided with a peripheral groove 7a in which the cables 8 and 9 engage.

In rest position, the end 10a of the cable 10 is arranged on a radial line Z0 relative to the axis of rotation X0, which can for example be included in the XZ plane. The respective ends 8a, 9a of cables 8, 9 could be arranged on a single diametrical line Y0 which intersects the axis X0. The radial line Y0 can be substantially perpendicular to the radial line Z0. In the rest position, the cable 10 can extend substantially parallel to the radial line Z0 and the cables 8, 9 substantially perpendicular to the diametrical line Y0.

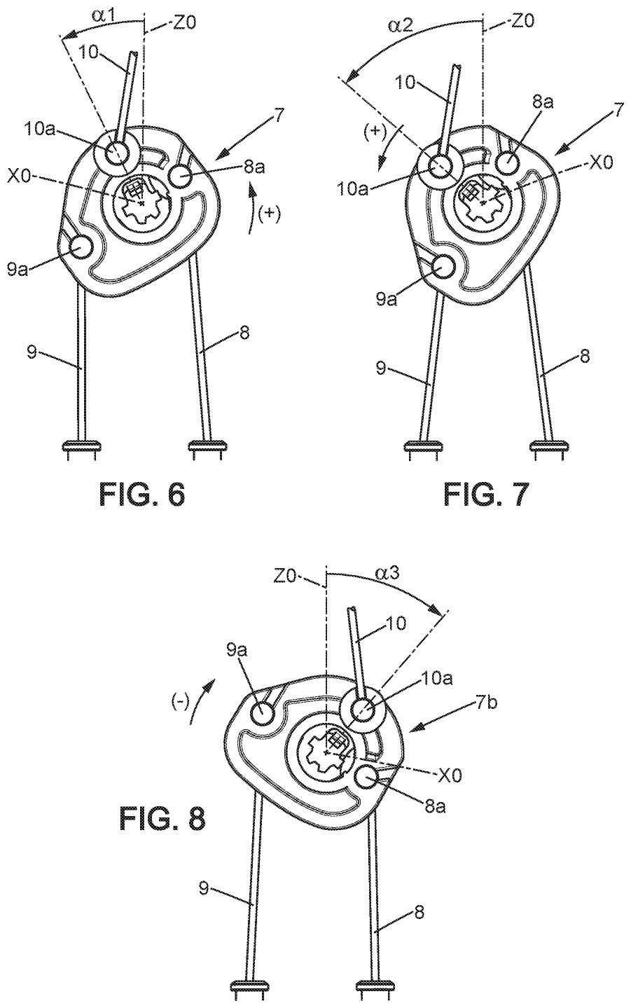

When a user wants to actuate mechanism A, in the example considered for folding the seatback 3 down forward, for example to the horizontal, the command member 6a and the rotary actuator 7 must be turned in a first rotation direction (+), corresponding to a traction on the cable 8, by a first angle α1 (FIG. 6). The first angle α1 is chosen for unlocking the mechanism A; it can for example be included between 30 and 70°, preferably between 40 and 60°. In this position, the cable 9 is released such that the mechanism B is not unlocked. Further, reflecting the fact that the end 10a of the cable 10 and the corresponding end 13a of the sleeve 13 are aligned along the radial direction Z0 in rest position (FIG. 5), this movement only creates a small amplitude traction on the cable 10, insufficient for actuating the mechanism C.

If the user wants to further unlock the mechanism C for retracting the head rest 4 while folding down the seat 3, the user continues the pivoting of the command member 6a in the first direction (+), up to a second angle α2 (FIG. 7), greater than al and sufficient for actuating the mechanism C. The second angle α2 can for example be included between 80 and 140°, preferably between 90 and 130°.

If the user wants to fold the entire seat 1 down forward, as shown in FIG. 4a, the user turns the command member 6a in a second direction (−) opposite the first direction (+) (FIG. 8), by an angle α3 which can for example be included between 80 and 130°, so as to exert traction on the cable 9 and thus unlock the mechanism B. In this position of the rotary actuator 7, the cable 8 is released and therefore the mechanism A is not actuated, while the traction on the cable 10 has sufficient amplitude for unlocking the mechanism C, for the reasons already disclosed with reference to FIGS. 6 and 7.

1. An automotive vehicle seat, comprising:
a first mechanism;
a second mechanism; and
a command device comprising a rotary actuator mounted pivoting around an axis of rotation and connected to the first mechanism and to the second mechanism, wherein the rotary actuator is elastically urged towards a rest position, and wherein the command device is configured to command the first mechanism when the rotary actuator is actuated in a first rotation direction from the rest position and configured to command the second mechanism when the rotary actuator is actuated in a second direction of rotation opposite to the first direction of rotation from the rest position.

2. The automotive vehicle seat according to claim 1, wherein the rotary actuator is elastically urged by a spring.

3. The automotive vehicle seat according to claim 1, further comprising a first cable connected to the first mechanism and a second cable connected to the second mechanism, where the first cable has one end fixed to the rotary actuator and the second cable has one end fixed to the rotary actuator.

4. The automotive vehicle seat according to claim 3, wherein the rotary actuator comprises a peripheral groove in which the first cable and the second cable are engaged.

5. The automotive vehicle seat according to claim 1, further comprising a third mechanism where the command device is configured to:
command the first mechanism when the rotary actuator is moved in the first direction of rotation by at least a first angle starting from the rest position;
command the third mechanism when the rotary actuator is actuated in the first direction of rotation by at least a second angle starting from the rest position, wherein the second angle is greater than the first angle.

6. The automotive vehicle seat according to claim 5, comprising a first cable connected to the first mechanism and a second cable connected to the second mechanism, wherein the first cable has one end fixed to the rotary actuator and the second cable has one end fixed to the rotary actuator, the automotive vehicle seat further comprising a third cable connected to the third mechanism, wherein the third cable has one end fixed to the rotary actuator, wherein the third cable is mounted sliding in a sleeve having one sleeve end towards the rotary actuator, wherein said third cable end and the sleeve end are substantially aligned with a radial direction relative to the axis of rotation of the rotary actuator when said rotary actuator is in the rest position.

7. The automotive vehicle seat according to claim 1, comprising a seat bottom and a seatback mounted pivoting around a horizontal axis of rotation, wherein the first mechanism is configured to command the seatback to fold down forward and/or wherein the second mechanism is configured to command a tilting of the seat forward.

8. The automotive vehicle seat according to claim 5, comprising a seat bottom and a seatback mounted pivoting around a horizontal axis of rotation, wherein the first mechanism is configured to command the seatback to fold down forward and/or wherein the second mechanism is configured to command a tilting of the seat forward, the automotive vehicle seat further comprising a headrest mounted on the seatback movable upward and downward, wherein the third mechanism is configured to command a retraction of said headrest to low position.

9. The automotive vehicle seat according to claim 1, wherein the command device comprises a command member suitable for allowing a user to actuate the rotary actuator.
